(19) United States
(12) Patent Application Publication
(10) Pub. No.: US 2014/0325396 A1
(43) Pub. Date: Oct. 30, 2014

(54) METHODS AND SYSTEMS FOR SIMULTANEOUS DISPLAY OF MULTIMEDIA DURING A VIDEO COMMUNICATION

(71) Applicant: VONAGE NETWORK LLC, Holmdel, NJ (US)

(72) Inventors: BARUCH STERMAN, EFRAT (IL); IDO MINTZ, Burgata (IL); Itay Bianco, Tel-Aviv (IL); Sagie Machlin, Rishon LeZion (IL)

(73) Assignee: Vonage Network LLC, Holmdel, NJ (US)

(21) Appl. No.: 13/873,792

(22) Filed: Apr. 30, 2013

(51) Int. Cl. H04L 29/06

(52) U.S. Cl. CPC H04L 65/403
USPC 715/756

(57) ABSTRACT

A method and system for simultaneous display of a multimedia background is disclosed. In some embodiments the system and method includes conducting a video call from a first caller on a first terminal to a second caller on a second terminal and substituting a multimedia content for at least a portion of an original background of the first terminal to create a combined multimedia background. The combined multimedia background is transmitted to the second terminal. Moreover, the combined multimedia background includes an image superimposed over the multimedia content. The combined multimedia background is enabled to be interactively controlled by a movement detection device.

### BACKGROUND OF THE INVENTION

1. Field of the invention

The present invention generally relates to methods and systems for sharing multimedia content during a video communication session.

2. Description of the Related Art

As consumers and businesses depend more and more on remote collaboration capabilities, demand for making these collaborative processes is growing. Needs for collaborative processes include business collaboration, entertainment, social networking and mobile communication. Instances may arise when making a video call that the callers may wish to share content such as documents, pictures, music, etc. Thus, the information may be in a variety of multimedia formats. In some cases it may be beneficial to allow both the callers and the multimedia content to be viewed on the same screen. Rather than simply sending the files to the callers, it would be advantageous to share the multimedia content in the form of a background or wallpaper during the video call. Moreover, it would be advantageous to enable interaction with the background during the video call. This virtual interaction with the content would allow for a richer call experience.

Well known methods are available to provide “green screen” backgrounds in video display. Green screens or Chroma key compositing, has been used heavily in many fields to remove a background from the subject of a photo or video—particularly the newscasting, motion picture and videogame industries. A color range in the top layer is made transparent, revealing another image behind. Some of these methods have been used in video communication applications.

However, these “green screen” methods as applied to video communication technologies do not provide for the background to be shared among callers of a video call and they do not enable shared interactivity of the background among the callers. Moreover, “green screen” methods are not suited to video communication because the background in a video communication session is not fixed.

Accordingly, there is a need for sharing multimedia information in the form of an interactive a background to a video call and allowing the participants the ability to interact with the background with detected motions and gestures.

### SUMMARY OF THE INVENTION

A method and system for simultaneous display of a multimedia background is disclosed. In some embodiments the system and method includes conducting a video call from a first caller on a first terminal to a second caller on a second terminal and substituting a multimedia content for at least a portion of an original background of the first terminal to create a combined multimedia background. The combined multimedia background is transmitted to the second terminal. Moreover, the combined multimedia background includes an image superimposed over the multimedia content. The combined multimedia background is enabled to be interactively controlled by a movement detection device.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communications system including a first terminal and a second terminal in accordance with one or more exemplary embodiments of the invention;

FIG. 2 is a block diagram of an exemplary terminal in accordance with one or more embodiments of the invention;

FIG. 3 is an illustration of an exemplary communication session in accordance with one or more embodiments of the invention;

FIG. 4 is a flow diagram of an exemplary communication session with a simultaneous display of a multimedia background in accordance with one or more embodiments of the invention;

FIG. 5 is a diagram of an exemplary system in which the simultaneous display of a multimedia background is accomplished through a server in accordance with one or more embodiments of the invention;

FIG. 6 is a flow diagram of an exemplary communication session in which the simultaneous display of a multimedia background is accomplished through a server in accordance with one or more embodiments of the invention;

FIG. 7 is a flow diagram of an exemplary communication session in which the simultaneous display of multimedia background is merged with the image of a first caller on a server;

FIG. 8 is a diagram of an exemplary system in which the multimedia sharing is accomplished through a terminal; and

FIG. 9 is a flow diagram of an exemplary communication session in which the simultaneous display of multimedia background is accomplished through a terminal.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

In embodiments consistent with the present invention, a video call may be initiated by methods well known in the art.

In some embodiments, the invention is described as practiced on a local user device such as a handheld mobile device. However, the invention may also be practiced on a desktop computer, a server based environment or other devices capable of video communications.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

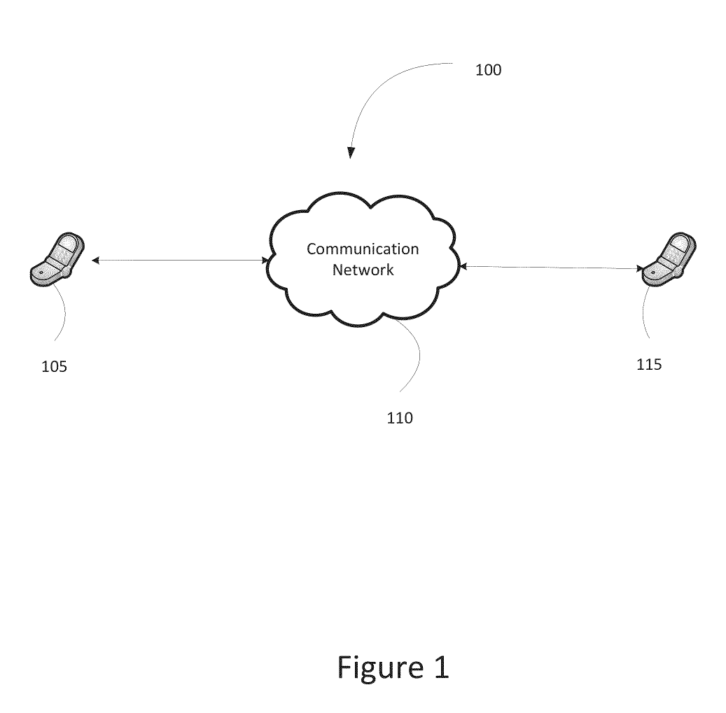

FIG. 1 depicts a mobile communications system 100 including a first terminal 105 and a second terminal 115. The exemplary mobile communications system 100 comprises a communications network 110, the first terminal 105, and the second terminal 115. The communications network 110 may be one or more networks such as Internet Protocol (IP) networks or public switched telephone networks (PSTN) used to connect the first 105 and second terminals (e.g. devices) 115.

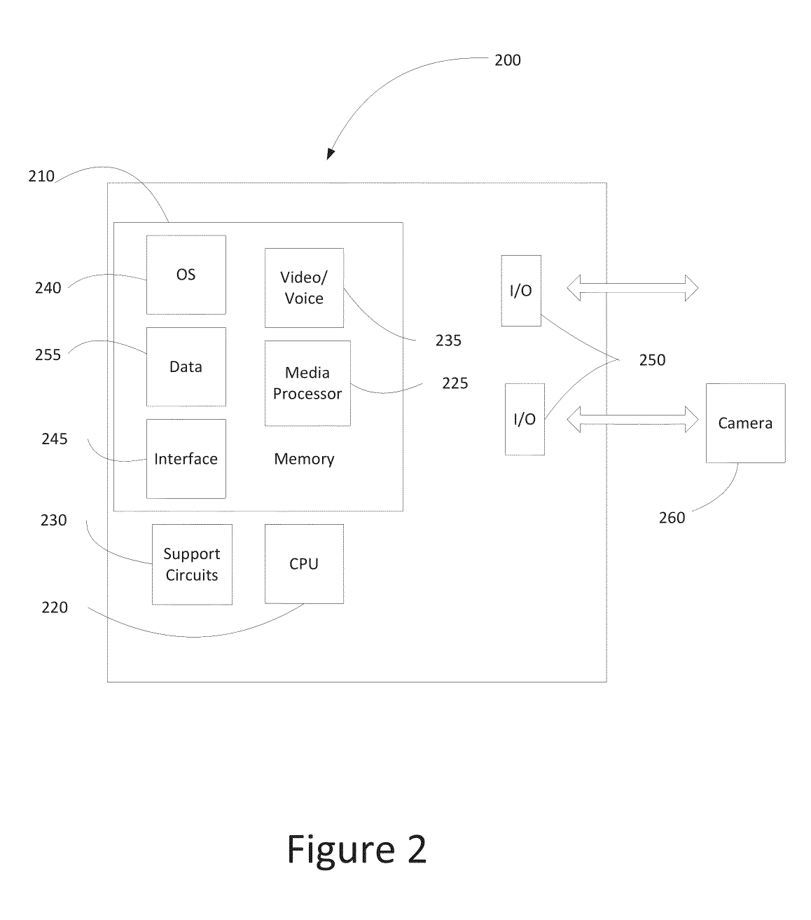

FIG. 2 depicts an exemplary diagram representation of elements of a terminal 200 embodying the invention. Terminal 200 includes a CPU 220, support circuits 230, memory 210, and input/output (I/O) interface 250. The support circuits 230 include circuits for interfacing with the CPU 220 and input/output interface 250. The I/O interface 250 includes communication with a camera 260. The I/O interface 250 may also include a speaker, microphone, touch screen, buttons and the like for a user to interact with the terminal 200. The camera 260 can be used for motion and gesture detection to allow for interaction with a displayed background as will be discussed below. Camera 260 may be a depth camera that identifies the three dimensional coordinates of a user and the coordinates can be used as input for control of the displayed background. One skilled in the art would understand that the functionality may be controlled by other motion detection devices to replace embodiments exemplified by camera 260. Alternatives include, but are not limited to, other optical devices such as infrared sensors, tomographic motion detection devices, magnetic field detectors and the like.

The memory 210 includes an operating system 240, a media processing module 225, a voice and video communication module 235, a data communication module 255 and a user interface module 245. The operating system 240 controls the interoperability of the support circuits 230, CPU 220, memory 210 and the I/O interface 250. The user interface module 245 contains instructions for the I/O interface 250 to interact with the operating system 240 such as for operation of a Graphical User Interface (GUI).

The media processing module 225 provides for media capture, processing, and encoding operations. In some aspects, the media processing module 225 is configured to combine the video stream of a video call with another set of video data or still image data, such as to produce a single output video. In some aspects, the media processing module 225 applies various post-processing effects to the output video in order to make the output video appear as if it was generated from a single video stream, In some aspects, the media processing module 225 operates to eliminate or process out some or all of an existing background in order to support the insertion or layering of documents, video/music controls, pictures and other media and to assemble the inserted background and video call in a single output. In some aspects, the media processing module 225 may interface with a template associated with a particular video call to facilitate the combination of a video call and a background to create a single output containing both the video call and the particular multimedia content.

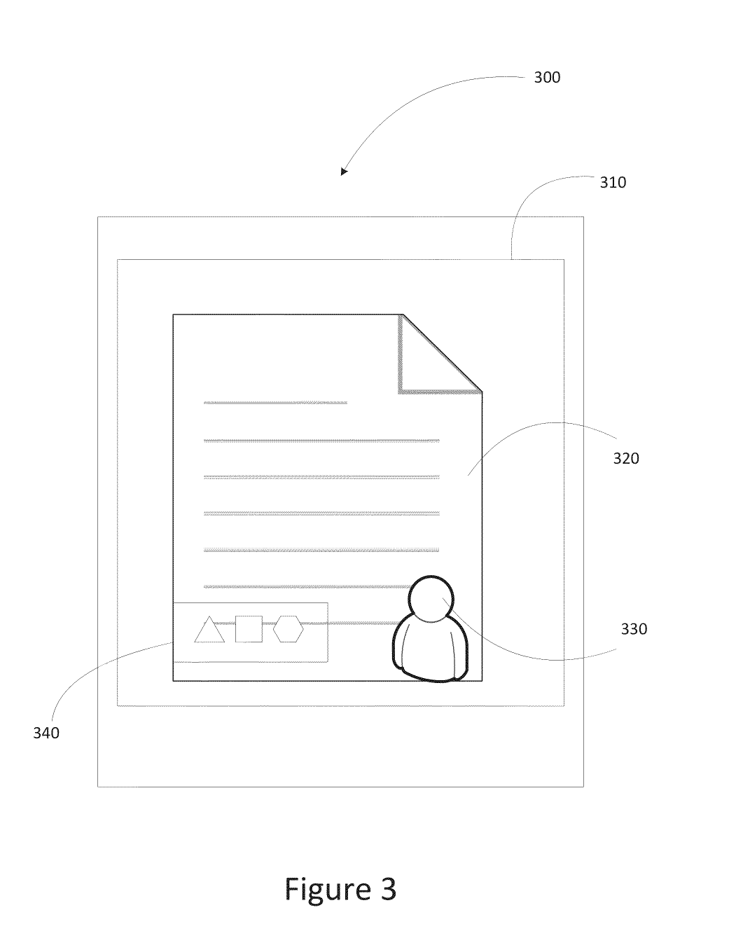

FIG. 3 is an illustration of an exemplary communication session 300 in accordance with embodiments of the invention. A Graphical User Interface (GUI) 310 is used during an exemplary communication session 300 implemented on terminal 200. The GUI 310 includes an image of the caller 330, a multimedia background 320 and controls 340. Controls 340 are used to control aspects of multimedia background 320. The images on GUI 310 are seen on the terminals of other participants of a video call and may include a preview screen to be viewed by the originating caller in order to adjust and properly control the multimedia background 320. The multimedia background 320 may be any media including text, video, images, music playlists, web pages, games or the like. The multimedia background 320 is interactive with controls 340 enabled to change depending on the background media chosen. The image of callers 330 are superimposed over multimedia background 320. The location of the image of caller 330 is dynamically movable such that the image 330 is not obstructing key features of multimedia background 320. The camera 260 detects gestures and motions to enable the operation of the controls 340 and also allow for other manipulation and operation of multimedia background 320 so that control of multimedia background 320 is not limited to the functionality of the controls 340. For example, scrolling, selecting an object, dragging and dropping and the like may be accomplished by gestures and motions made over the multimedia background 320 itself rather than through the controls 340.

In some embodiments, the image of the caller 330 is separated from the original background of the video call through the use of face recognition methods well known in the art. In this embodiment, the image of the caller 330 is preserved and the original background is replaced by a selected multimedia background 320.

In other embodiments, the image of caller 330 is separated from the original background by detecting static or near static pixels. The image of the caller 330 is preserved in the foreground while the detected static or near static pixels that constitute the original background are replaced by the selected multimedia background 320.

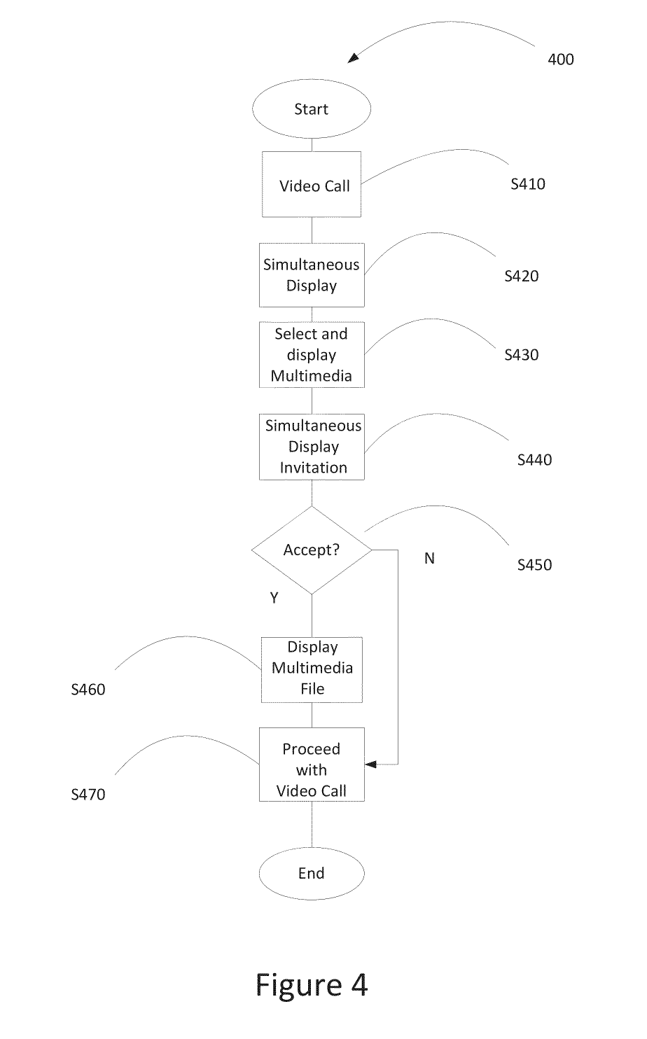

FIG. 4 is a flow diagram of an exemplary communication session 400 for a simultaneous display of a multimedia background 320 in accordance with embodiments of the invention. The method starts at step S410 with the communication session as a video call from a first caller on first terminal 105 to a second caller on second terminal 115 using well known methods in the art. A simultaneous multimedia display mode is initiated at step S420 on first terminal 105 by opening GUI 310. A drop down menu on GUI 310 may present a list of available multimedia content. At step S430, a multimedia content is selected from the list of available content presented via GUI 310 on first terminal 105 and inserted as the multimedia background 320. The multimedia background 320 is now displayed and enabled for interaction on first terminal 105. The video call proceeds in which the first terminal 105 transmits the multimedia background 320 with an image of the first caller 330 superimposed over it to the second terminal.

At step S440, an invitation is sent from first terminal 105 to the second caller on the second terminal 115 to share the multimedia background 320. If the invitation is accepted at step S450, then at step S460 first terminal 105 will transmit the multimedia background 320 to second terminal 105 such that multimedia background 320 also becomes the multimedia background 320 of second terminal 115. The first terminal 105 enables the second terminal 115 to interact with multimedia background 320. The video call proceeds at step S470 with each terminal sharing and interacting with the multimedia background 320 simultaneously. The first terminal 105 transmits the multimedia background 320 to the second terminal 115 with an image of the first caller 330 superimposed over multimedia background 320. The first terminal 105 displays multimedia background 320 with an image of the second caller 330 superimposed over the multimedia background 320. Alternatively, both callers can be displayed superimposed over the multimedia background 320.

If the invitation is rejected at step S450, then the video call proceeds at step S470 with only first terminal 105 interacting with the multimedia background 320. First terminal 105 will transmit an image of the multimedia background 320 with first caller 330 superimposed over multimedia background 320 to the second terminal 115. First terminal 105 will display an image of the second caller as in a normal video call.

In some embodiments of the invention, multiple parties may be included in the video call to share and interact with the simultaneous display of multimedia background content. In this embodiment the multiparty call can serve as a conference call with each party interacting with the multimedia content.

In some embodiments of the present invention, a document is selected in step S430. Multimedia background 320 will be displayed as the chosen document and may be interactively controlled. The document may be annotated, highlighted, or resized, for instance, as it would be in a generally available word processing program. Controls 340 will be appropriately displayed to allow for the word processing functionality. Camera 260 detects motions over controls 340 to execute the word processing. Control of the document is not limited, however, to the functions of the controls 340. Camera 260 may also detect gestures and motions over multimedia background 320 for dragging and dropping, moving the document and other functions.

In another embodiment of the present invention, a picture is selected in step S430 as multimedia background 320. The appropriate controls 340 will be displayed on GUI 310 to enable the picture to be annotated, resized, or include other editing features which are controlled by gestures and motions over the controls 340. Additionally, dragging and dropping, moving the image and other functions may be performed through gestures and motions over the multimedia background 320.

In other embodiments of the present invention, a video is selected in step S430 as multimedia background 320. GUI 310 displays appropriate controls 340 for playing, rewind, fast forward and other functions available on a video player. The camera 260 detects motions such that one of the controls 340 may be selected to operate the video accordingly. Annotation or other functionality may also be available on controls 340. Additionally, other functions to manipulate or edit the video directly through gestures and motions over multimedia background 320.

In other embodiments of the present invention, a music file is selected in step S430 as multimedia background 320. GUI 310 displays appropriate controls 340 for playing, rewind, fast forward and other functions available on a music player. The camera 260 detects gestures and motions such that the controls 340 may be selected to manipulate the music accordingly. Additionally, a playlist may be displayed. The list of songs may be scrolled and selected, for example. Scrolling through the list, selections made and other functions controlling the list or the music may also be accomplished by gestures and motions detected over the multimedia background 320 rather than through controls 340.

In other embodiments of the present invention, a map is selected in step S430 as multimedia background 320. GUI 310 displays appropriate controls 340 to size, highlight directions, annotate or perform other functions to control the display of the map. Scrolling, moving and sizing may also be accomplished by gestures and motions detected over the multimedia background 320.

In other embodiments of the present invention, an animation is selected in step S430 as multimedia background 320. Appropriate controls 340 may be made available to manipulate, draw, move, or allow other control functions for the animation, for example. Animation characters and objects may be clipped and dragged onto the multimedia background 320 by motions detected over the background 320.

In other embodiments of the present invention, a game is selected in step S430. GUI 310 may display an appropriate game controller 340. Other callers may share multimedia background 320 to participate in the game together, each manipulating separate controllers but viewing and manipulating the same multimedia background 320.

In another embodiment of the methods of the present invention, a web page is selected in step S430 as multimedia background 320. The appropriate controls 340 will be displayed on GUI 310 to enable the selection of items on the web page, resize the page or include other features. Moving the web page, highlighting areas and other functions may be performed through gestures and motions over the multimedia background.

In another embodiment of the methods of the present invention, on a mobile device a different application is selected in step S430 and displayed as the multimedia background 320. The appropriate controls 340 will be displayed on GUI 310 to enable operation of the application. Some functions may be performed through gestures and motions over the multimedia background.

In other embodiments of the methods of the present invention, multiple callers may participate and be shown in the simultaneous display with each interacting with the selected multimedia background 320. The callers may appear individually or all together as multiple callers 330.

In the embodiments of the present invention the callers 330 may in addition be able to expand or shrink his/her size displayed in GUI 310 by detected gestures and motions over the image of the callers 330.

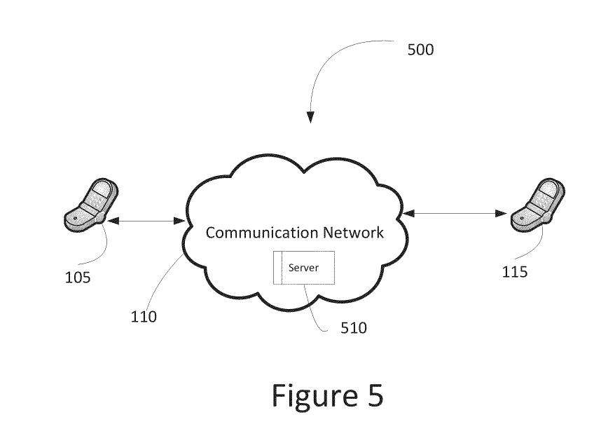

FIG. 5 is a diagram depicting communication session 500 in which the multimedia background 320 resides on a server 510 or other remote device in communication with communication network 110 and is displayed in the GUI 310 on terminals 105 and 115. Each caller 330 controls the interaction with multimedia background 320 from their respective terminals.

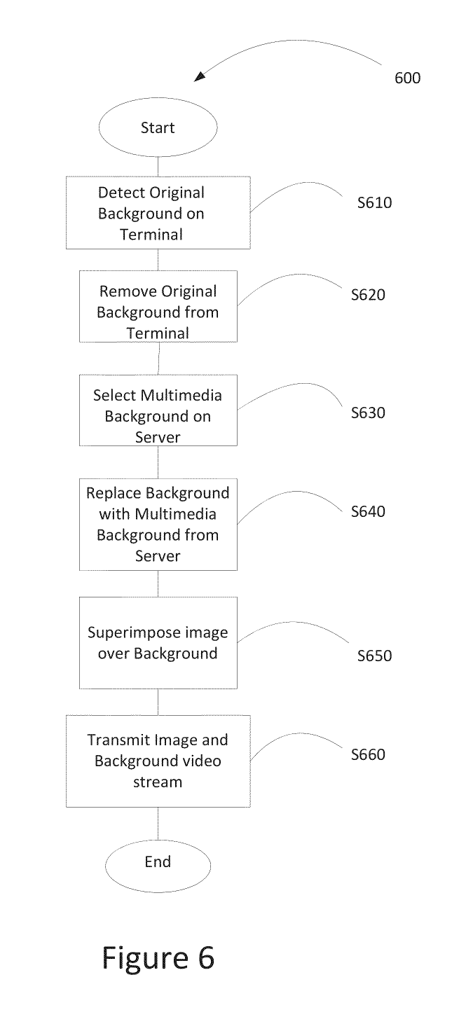

FIG. 6 is a flow chart of an exemplary communication session 600 in which the simultaneous display of multimedia background 320 is accomplished through server 510. At step S610, the original background of first terminal 105 is detected and removed at step S620. At step S630 a multimedia background 320 is selected on server 510. The selected multimedia background 320 residing on server 510 replaces the original background on terminal 105 at step S640. The image of the first caller 330 on first terminal 105 is superimposed over the multimedia background 320 at step S650. At step S660, the superimposed image of first caller 330 with the multimedia background 320 is transmitted from first terminal 105.

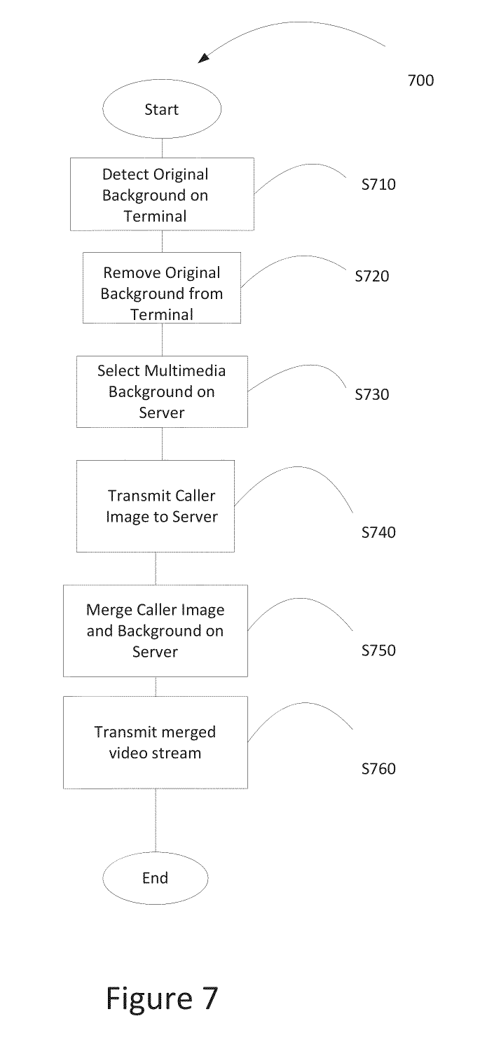

FIG. 7 is a flow chart of an exemplary communication session 700 in which the simultaneous display of multimedia background 320 is merged with the image of first caller 330 on server 510. At step S710 the original background of first terminal 105 is detected and removed at step S720. At step S730 a multimedia background 320 on server 510 is selected. At step S740 the image of first caller 330 is transmitted to server 510. The image of the first caller 330 is merged with the multimedia background 320 on server 510 at step S750. At step S760, the resulting merged image is transmitted as one video stream.

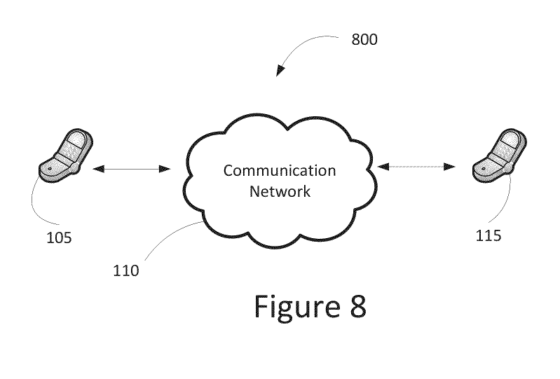

FIG. 8 is a diagram depicting communication session 800 in which the multimedia background 320 resides on the local device 105. The multimedia background 320 resides on the terminal 105 and is inserted into GUI 310 on both terminals 105 and 115 communicating through communication network 110. Each caller 330 controls the interaction with multimedia background 320 from their respective terminals.

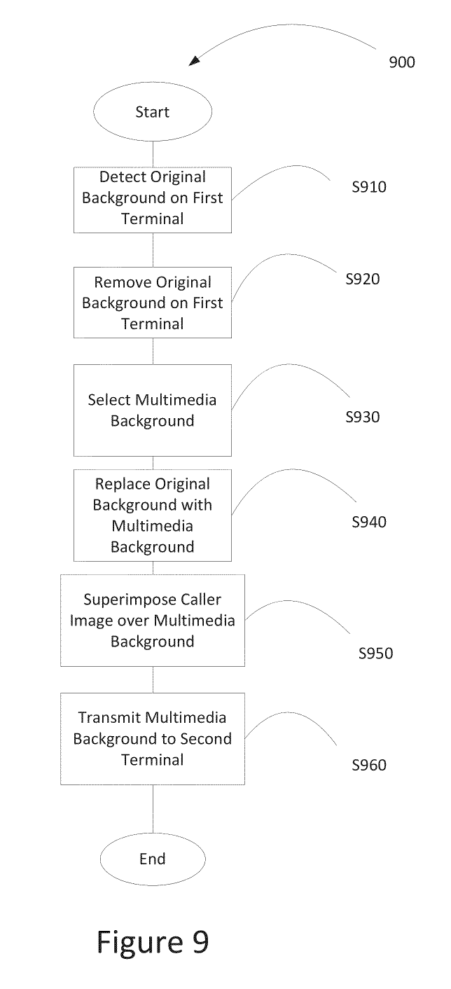

FIG. 9 is a flow chart of an exemplary communication session 900 in which the simultaneous display of multimedia background 320 is accomplished through first terminal 105. At step S910 the original background of first terminal 105 is detected and removed at step S920. At step S930 a multimedia background 320 is selected on first terminal 105. The selected multimedia background 320 replaces the original background on terminal 105 at step S940. The image of the first caller 330 on first terminal 105 is superimposed over the multimedia background 320 at step S950. At step S960, the multimedia background 320 is transmitted to second terminal 115.

The embodiments discussed and figures presented are meant only as examples to illustrate the embodiments of the invention and are not intended as a limitation of the invention. Many variations may be employed in embodiments of the invention.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for simultaneous display of a multimedia background comprising:
conducting a video call from a first caller on a first terminal to a second caller on a second terminal;
substituting a multimedia content for at least a portion of an original background of the first terminal to create the multimedia background; and
transmitting the multimedia background to the second terminal.

2. The method of claim 1, further comprising providing for substituting at least a portion of the multimedia background for at least a portion of an original background of the second terminal.

3. The method of claim 1, wherein substituting a multimedia content for at least a portion of an original background further comprises:
detecting static or near static pixels of the original background; and
replacing the detected static or near static pixels with the multimedia content.

4. The method of claim 1, wherein the multimedia background comprises an image captured by the first terminal superimposed at least in part over the multimedia background.

5. The method of claim 1, wherein the multimedia background comprises an image captured by the second terminal superimposed at least in part over the multimedia background.

6. The method of claim 1, wherein the multimedia background comprises an image captured by the first terminal and an image captured by the second terminal superimposed over the multimedia background.

7. The method of claim 1, wherein the multimedia background is interactive.

8. The method of claim 1, wherein the multimedia background comprises a document, an image, a video, a music file, a game, a web page or a list.

9. The method of claim 8, wherein the multimedia background further comprises controls appropriate for the multimedia background.

10. The method of claim 9, wherein the multimedia background is responsive to detected movement.

11. The method of claim 10, wherein the movement is detected by an image-capturing module on either the first terminal or the second terminal.

12. The method of claim 1, wherein substituting a multimedia content for at least a portion of an original background further comprises:
detecting an image of a human being; and
replacing a portion of the original background not corresponding to the image of the human being with a multimedia content.

13. The method of claim 12, wherein detecting an image of a human being comprises recognizing a human face.

14. The method of claim 1, wherein the multimedia content resides on the first terminal.

15. The method of claim 1 wherein the multimedia content resides on a server.

16. A system for a simultaneous display of a multimedia background comprising:
a terminal;
a movement detection device connected to the terminal;
a display mounted to the terminal; and
a Graphical User Interface (GUI) running on the terminal configured to:
conduct a video call from a first terminal to a second terminal;
substitute a multimedia content for at least a portion of an original background of the first terminal to create the multimedia background; and
transmit the multimedia background to the second terminal.

17. The system of claim 16, further configured to provide for substituting the multimedia background for an original background of the second terminal.

18. The system of claim 16, wherein the multimedia content resides on the first terminal.

19. The system of claim 16, wherein the multimedia content resides on a server.

20. The system of claim 16, wherein the multimedia background is responsive to detected movement detected by an image-capturing module on either the first terminal or the second terminal.
